(19) United States
(12) Patent Application Publication
(10) Pub. No.: US 2006/0004687 A1
(43) Pub. Date: Jan. 5, 2006

(54) Web-based event correction and prevention system

(76) Inventors: Amy H. Boyd, Neenah, WI (US); Douglas A. Grief, Neenah, WI (US); Jane Charbonneau, Menasha, WI (US); Kathryn A. Schmit, Appleton, WI (US); Lisa A. Kennedy, Appleton, WI (US); Lisa LeComte, DePere, WI (US); Dan Povolny, Appleton, WI (US); Renee J. Pearson, Appleton, WI (US); Edward C. Wheaton, Graniteville, SC (US); John T. Lardie, Newtown, CT (US)

Correspondence Address: Dority & Manning, P.A., P.O. Box 1449, Greenville, SC, 29601, US

(21) Appl. No.: 10/881,697

(22) Filed: Jun. 30, 2004

(51) Int. Cl. G06F 17/30

(52) U.S. Cl. 707/1

(57) ABSTRACT

An event correction and prevention system for managing and analyzing unplanned event occurrences within a networked multi-facility corporate environment provides features and steps for entering event information via a computer-based platform into an automated system. Event information includes basic information such as a date, time and location of an unplanned occurrence as well as one or more event classifications associated with the occurrence. Event classifications may include injuries, illnesses, process losses, environmental losses, property damages, and near misses. Additional event details may include risk assessment ratings and corrective actions that are also investigated and implemented. Various entities are assigned to complete the investigative and follow up actions associated with an unplanned event and notifications are sent among such entities as certain actions are delegated and completed. Report generation tools are provided to collect selected information stored in the application database and present such information in various formats for a user.

### TECHNICAL FIELD OF THE INVENTION

The present invention generally concerns an automated system and corresponding method for managing unplanned actions, or events, that occur in a multi-facility corporate environment. A web-based event correction and prevention system is provided which allows for global tracking, recording, analysis and prevention of unplanned events.

### BACKGROUND

Corporations that design and manufacturer products are often responsible for the oversight of multiple facilities spread across a local, regional, national or global area. The utilization of multiple facilities leads to the employment of numerous individuals at each facility and a variety of different work tasks and processes that may occur at each location. Given such a large and broad spectrum of continual involvement and action on the part of a corporation's facilities, employees and processes, a risk of certain unplanned events occurring in the course of product design, manufacturing, shipping, etc. is inevitably present. “Events” as used herein may include such unplanned actions as an employee injury or illness, property damage, process loss, environmental loss, a “near miss” event, or some combination of a variety of these and other events.

In some conventional corporate environments, the recording and analysis of unplanned events was a manual process, which can tend to be cumbersome and inefficient in some respects. Manual event recording results in some difficulty in sharing recorded data across multiple corporate facilities, especially as the size of a corporation grows. Many previously manual data systems are being replaced by automated systems. For example, a computer-based system such as the one disclosed in U.S. Pat. No. 4,347,568 (Giguere et al.) provides a date entry and manipulation environment for occupational health and environmental surveillance. U.S. Pat. No. 6,341,287 (Sziklai et al.) provides an integrated system for managing changes in regulatory and non-regulatory requirements for business activities at an industrial or commercial facility. International patent application WO 02/084446 (Jacobs et al.) discloses a computer-based safety management system and method.

Despite the availability of various automated and computer-based systems for managing aspects of business, a need exists for an automated system for efficiently managing and analyzing unplanned events that provides for global tracking, recording, analysis and prevention of unplanned events.

### SUMMARY

Objects and advantages of the invention will be set forth in part in the following description, or may be obvious from the description, or may be learned through practice of the invention.

In general, the present invention is directed to a system and method that allows for global tracking, recording, analysis and prevention of unplanned events via an automated and networked environment. Multiple individuals on behalf of a given corporation are assigned various tasks associated with a given event, such as initial reporting, investigation, corrective action and review. These individuals may access the subject networked system to enter respective pieces of information which may then be stored in a centralized location and available for subsequent access, analysis and reporting.

Although the present invention is described herein with respect to the management and analysis of unplanned events in a corporate manufacturing environment, the features and steps disclosed herein may be readily extended to manage other types of events, such as those occurring in other specific environments.

An advantage in accordance with some embodiments of the present subject matter is that the automated system provides for versatility in the characterization of unplanned events. More particularly, events can be characterized under a variety of different classifications, including but not limited to, injuries, illnesses, property damage, environmental loss, process loss, near miss occurrences, and combinations of these or other events.

Another advantage in accordance with certain embodiments of the present invention is that event management and related correction and prevention analysis is effected via a computer-based system that is networked across multiple locations and facilities. As such, event data can be shared across facilities, thus providing a beneficial tool for widespread analysis and reporting, a learning initiative from the events of other people and facilities, and a way to assess and benchmark overall safety ratings for multiple facilities.

A still further advantage of some embodiments of the presently disclosed technology is that the subject system and method allows for multiple sub-events to be associated with a larger event occurrence, thus being able to associate multiple injuries, illnesses, etc. within a single unplanned occurrence and only requiring a single entry of the basic exposure occurrence while capturing multiple details about each subject involved. For example, an event may include an injury and property damage. Instead of entering two separate events in the subject system, only one is entered, avoiding duplication of information and linking the sub-events together. Alternatively, in the case of a chemical exposure, many people may become ill from a single unplanned occurrence (i.e., the exposure) and so linking of those illnesses to a single event becomes beneficial for various information management reasons.

A first aspect in accordance with some embodiments of the present invention corresponds to a user accessing a computer-based event correction and prevention system and entering basic information corresponding to an unplanned occurrence. Basic information may include, for example, a date, time and location of the unplanned occurrence, or event, as well as one or more event classifications for possible sub-events under the unplanned event occurrence. Exemplary event classifications may include injury, illness, process loss, environmental loss, property damage or a near miss. A basic user enters fundamental event information via a first data entry system that is linked to a network connecting the different entities involved in a process of managing and analyzing unplanned events. The basic user's data entry system may be linked to a web page that provides a graphical interface to assist the user in entering the basic event information. For example, the web page may provide specific data fields that a user must populate for proper establishment of an event log. Data fields for the event classification and other information may include drop down lists from which the user may select from a plurality of predetermined possibilities, thus helping to standardize certain event terminology.

Once basic event information is entered in the computer-based event correction and prevention system, an event log including such basic information may be stored in an application database and a task of performing subsequent analysis of the event is assigned to an investigator. The investigator may be selected by the basic user and may be automatically sent a notification indicating their investigative responsibilities. The investigator then investigates the unplanned event to determine additional event details including at least one risk assessment rating and one or more cause analysis items. All such additional details may also be entered into the computer-based event correction and prevention system via a second data entry system. Risk assessment ratings may include such exemplary ratings as a frequency of event occurrence within a given corporate environment, a probability of occurrence of the event type and a severity rating associated with the event type. The cause analysis items may fall under one of several cause categories, such as but not limited to basic causes, immediate causes and system needs.

Once cause analysis items are identified by an investigator, corrective actions may be assigned by the investigator to respective individuals who then follow up with corrective and preventative measures to respectively help rectify any undesirable results of an unplanned event and also help prevent the occurrence of future similar events. Corrective action tasks and completion dates are preferably entered into the computer-based event system via a third user interface linked to the network. Once all corrective actions are completed, the investigator is notified automatically. A reviewer may then be assigned to evaluate the results of the investigating step and determine the effectiveness of the completed corrective actions. A reviewer is responsible for closing out the event in the subject automated system.

An additional feature of the subject event correction and prevention system and method may correspond to a report generation feature whereby selected information can be collected from the application database and developed into either a preformatted or a user customized report. Advisory data collected for a report can be exported to a supplemental software program to facilitate customized data presentation and analysis.

Other event correction and prevention system features may include an interface for entering information from safety planned inspections that follow up and track quality-related aspects of an event investigation, an interface for tracking any type of corrective and preventative actions (CAPA) required by internal procedure of a given corporate environment or by regulatory requirement, and an interface to assist with the implementation of manual processes such as a safety management and assessment rating tool for evaluating safety and hygiene aspects of the given corporate environment.

A related aspect of the subject event correction and prevention system and method concerns an article of manufacture comprising a program storage medium readable by a computer having a memory, the medium tangibly embodying one or more programs of instructions executable by the computer to perform method steps for recording and analyzing unplanned events in a networked corporate environment. The method embodied by the computer-readable medium and executed by a computer may include such steps as interfacing with the one or more programs of instruction via a data entry interface to provide information corresponding to an unplanned event and sending automatic notifications to individuals associated with analyzing the unplanned event. Automatic notifications may be sent to an assigned event investigator who is chosen to determine additional details concerning the unplanned event, one or more corrective action assignees who are assigned to implement one or more corrective actions, and/or a designated reviewer who is chosen to evaluate the actions undertaken by the event investigator and the one or more corrective action assignees.

Other features and aspects of the present invention are discussed in greater detail below.

### BRIEF DESCRIPTION OF THE DRAWINGS

The foregoing and other features, aspects and advantages of the present invention will become better understood with regard to the following description, appended claims and accompanying drawings where:

FIG. 1 provides a block diagram representation of an exemplary process for utilizing an event correction and prevention system in accordance with one embodiment of the present invention;

FIG. 2 provides a schematic representation of the interaction among exemplary hardware components of a web-based event correction and prevention system in accordance with one embodiment of the present invention; and

FIG. 3 provides a block diagram illustration of a computer-based platform including exemplary system features in accordance with one embodiment of a web-based event correction and prevention system of the present invention.

### DETAILED DESCRIPTION OF THE PREFERRED EMBODIMENTS

The invention will now be described in detail with reference to particular embodiments thereof. The embodiments are provided by way of explanation of the invention, and are not meant as a limitation of the invention. It will be apparent to those skilled in the art that various modifications and variations can be made in the present invention without departing from the scope and spirit of the invention. For example, features described or illustrated as part of one embodiment may be used with another embodiment to yield a still further embodiment. Thus, it is intended that the present invention include these and other modifications and variations as come within the scope and spirit of the invention, including the appended claims and their equivalents.

Corporate environments may include multiple facilities, employees and processes to achieve such tasks as product design, manufacturing, packaging and supplying. In light of the variety of factors that contribute to a business environment, the possibility of unplanned events occurring is prevalent. As such, a networked computer system and corresponding methodology has been developed that allows for global tracking, recording, analysis and prevention of unplanned events. Multiple individuals on behalf of a given corporation are assigned various tasks associated with a given event, such as initial reporting, investigation, corrective action and review. These individuals may access the subject networked system to enter respective pieces of information which may then be stored in a centralized location and available for subsequent access, analysis and reporting.

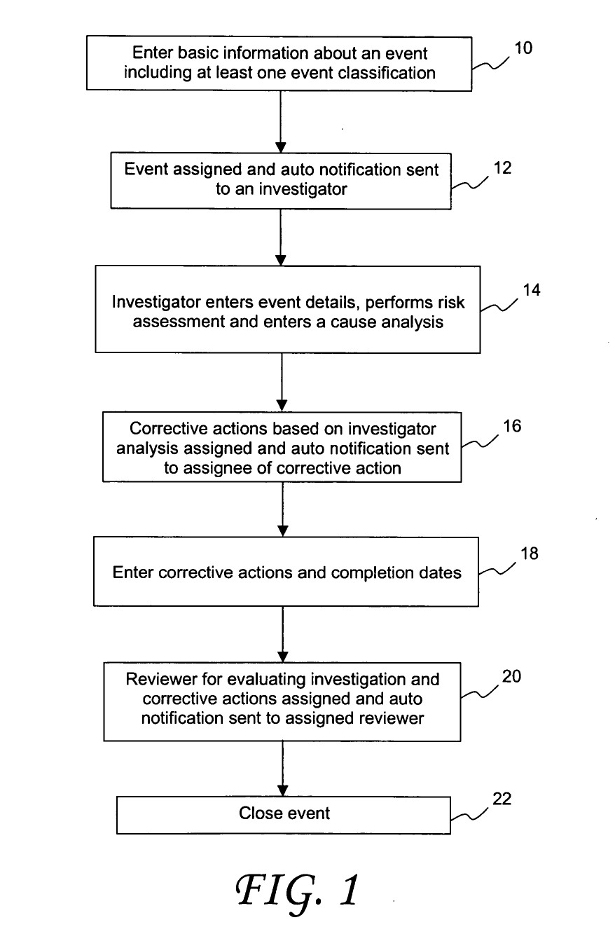

Referring now to FIG. 1, exemplary steps in accordance with one embodiment of an event correction and prevention system and method of the present invention are now presented. A first step 10 in such a method is to enter basic information about an event, or unplanned occurrence. Basic information may include such information as the date, time and location of an event as well as an event classification. Events may be classified in any number of ways, including but not limited to, injury or illness, property damage, process loss, environmental loss, a near miss, or a combination of these or other event types. An example of an injury event may correspond to an employee breaking his arm in a slip and fall type occurrence while working on the job. An example of an illness event could be when one or more individuals become ill after being inadvertently exposed to a hazardous chemical material during a manufacturing process. Examples of a property damage event may include instances when raw materials or goods are damaged or destroyed when they are removed from storage or delivered to a production line. A process loss event may occur, for example, when a manufacturing line is forced to shut down for an unintended period of time. An exemplary environmental loss may occur when a hazardous material spill occurs at a manufacturing facility and pollutes a water supply or affects nearby wildlife populations. A near miss corresponds to an occurrence that could have resulted in an event such as injury, property damage, loss, etc., but that was prevented or limited in some fashion.

Referring still to FIG. 1; the basic information about an event as entered in step 10 may be effected by any basic user having access to a corporate network, such as an intranet, local area network (LAN) or even a globalized network such as the Internet. After obtaining access to the event correction and prevention system, a basic user may be provided with a graphical interface such as a web page having a plurality of data fields which must be populated. Some data fields may include drop down lists from which a user can select from certain standardized options, such as a plurality of predefined event classifications (e.g., injury, process loss, etc.) After an event classification is entered in step 10, additional data fields may be required for the user to provide further information regarding the particular event type. For example, if the user designates in step 10 that a new event was a process loss, the duration of time of the ensuing process loss and the type of process may need to be entered. An amount of versatility is afforded in determining what information will be considered as “basic” information entered in step 10 versus other types of information to be provided in subsequent steps.

A distinguishing feature to note in accordance with step 10 of the embodiment illustrated in FIG. 1 is that multiple sub-events may be entered and associated with a general event occurrence, thus being able to associate multiple injuries, illnesses, etc. within a single unplanned occurrence and only requiring a single entry of the basic exposure occurrence (e.g., date, time, location, etc.) while subsequently capturing multiple details about each subject involved. For example, an event may include an injury and property damage. Instead of entering two separate events in the subject system, only one is entered, avoiding duplication of information and linking the sub-events together. Alternatively, in the case of a chemical exposure, many people may become ill from a single unplanned occurrence (i.e., the exposure) and so linking of those illnesses to a single event becomes beneficial for many reasons.

Once a user provides basic information in step 10 corresponding to a specific event, the user can then assign in step 12 an investigation associated with the event. Investigations may be assigned for every injury, illness, property damage, process loss, environmental loss, etc. entered into the event correction and prevention system, although it should be appreciated that investigations may not be required for some events such as but not limited to near misses and events for which investigations have previously been assigned. For example, if a single unplanned occurrence results in both injury and property damage, investigations may be assigned for both the injury and the property damage. An investigator may be assigned in step 12 by the user who enters the basic event information in step 10. In one embodiment, multiple investigators may be assigned for multiple respective sub-events that result from a single unplanned occurrence. While multiple investigators may be assigned, in some embodiments, only a single investigator is assigned to an event having multiple respective sub-events and thus only one individual is automatically notified of the assignment. Event investigators are trained to perform their assigned tasks and may be directly affiliated with the corporation employing the event correction and prevention system or may be contracted out from a third party. When the investigator is assigned in step 12, a signal generator linked to the computer-based event prevention and correction system transmits a notification to the assigned investigator. Notifications may be sent in a variety of fashions, including but not limited to postal mail, electronic mail (e-mail), facsimile, telephone, etc.

Referring still to FIG. 1, an investigator then further assesses the event to determine additional details about the event that are then entered in step 14 via a data entry system coupled to the web-based event correction and prevention system. The investigator also performs a risk assessment for the event in step 14, which is also entered by the investigator into the system. Risk assessments can provide a relatively simple representation such as an alphanumeric rating on a predetermined risk scale or alternatively can be more comprehensive and include such information as the frequency of the event type within a corporate sector, the probability of occurrence of the event type and a severity rating associated with the event type. In further accordance with exemplary step 14, an investigator also enters a cause analysis where immediate causes, basic causes and system needs are identified. Multiple items can be entered under each of these three cause categories. A systematic approach is followed by the investigator to identify all the cause analysis items for a given event.

After an investigator determines cause analysis items as part of exemplary step 14, the investigator electronically assigns corrective action(s) based upon this analysis. Each corrective action entered can be tied back to a specific cause type under one of the three cause categories: basic causes, immediate causes and system needs. For example, if a basic cause for an employee illness was a chemical exposure, a corrective action for the chemical exposure is assigned by the investigator. The corrective action assignee is then responsible for following through with specific actions that are needed to rectify negative effects resulting from the event and to ensure that the risk for future related events is minimized as much as possible, thus facilitating future event prevention. The specific corrective actions and corresponding dates of completion are then entered into the system in step 18.

The investigators and corrective action assignees play an important role in the various steps and features of the subject event correction and prevention system. As such, ongoing notification and communication among these particular individuals who have access to the system is also important. When an investigator assigns corrective actions in exemplary step 16, the corrective action assignees are notified, for example, electronically via e-mail and are required to enter actions and completion dates by predetermined target due dates. Investigators and corrective action assignees receive a communication (e.g. e-mail) each day for each investigation or corrective action that has not been completed by the target date until completion information is entered into the web-based event correction and prevention system.

Referring still to FIG. 1, the investigator receives a notification when all corrective actions are completed in step 18, and a reviewer is then assigned in step 20. A reviewer may correspond to an individual either internally or externally affiliated with the corporation employing the event correction and prevention system. A reviewer evaluates the investigation, as well as the appropriateness and effectiveness of corrective actions. When the reviewer is satisfied with the quality of the investigation and follow-up, the reviewer closes out the event in step 22.

In accordance with the exemplary steps illustrated in FIG. 1, it should be appreciated that some embodiments of the present invention allow maximum flexibility for capturing data for an event classified as a “near miss.” A near miss event can be closed out on a single screen by the assigned investigator, thus greatly simplifying the exemplary process outlined in FIG. 1. Alternatively, a more comprehensive investigation of a near miss event may be carried out and recorded in the subject event correction and prevention system.

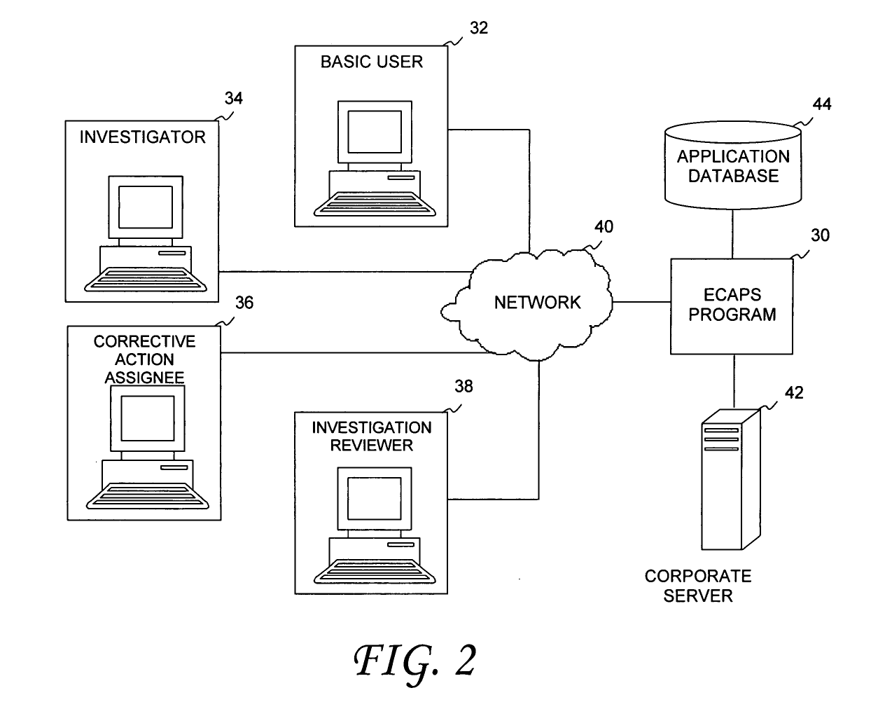

Referring now to other aspects of the present invention, FIG. 2 illustrates an exemplary relationship between several hardware components used in one embodiment of an event correction and prevention system of the present invention. In accordance with the exemplary embodiment illustrated in FIG. 2, multiple different entities can access the event correction and prevention system (ECAPS) application or program 30. Each entity has access to ECAPS application 30 via a computer provided with some sort of data entry system (e.g., keyboard, touch-screen monitor, mouse, scanner, etc.) Involved parties include one or more basic user(s) 32, investigator(s) 34, corrective action assignee(s) 36 and investigation reviewer(s) 38. All entities are linked via a network 40, which may correspond to a a corporate Intranet or other internal network of computers such as a LAN or to a global network such as the Internet. It should be appreciated that the plurality of basic users 32, investigators 34, corrective action assignees 36 and investigation reviewers 38 may have access to network 40 from a single facility or from a plurality of different respective facilities and corresponding locations.

An interface to the ECAPS application 30 may be provided to selected entities 32, 34, 36 and 38 as a web page, other browser interface or visual display. Data entry devices integrated with user computers connected to the network 40 can be employed to enter a URL to access a secure web site. The URL request goes through the network to a router (not shown) where corporate server 42 determines the IP address to be used for the requested URL. A signal for creating a web page display is then routed back to the requester's computer. Corporate server 42 is further configured to execute specific code or software included in ECAPS program 30.

Referring still to FIG. 2, an application database 44, which may be provided on corporate server 42 or on a separate dedicated server, stores data provided when new events are entered into the ECAPS application by a basic user 32. Application database also stores detailed information and analysis determined by investigators 34 as well as corrective action items effected by assignees 36. The event logs and corresponding information stored in database 44 may be searchable based on different selected data fields provided in the event logs. Any modifications made to existing event entries may also be stored in application database 44, including time stamps and identification information for the user who made such modifications such that event log changes can be subsequently tracked by audits.

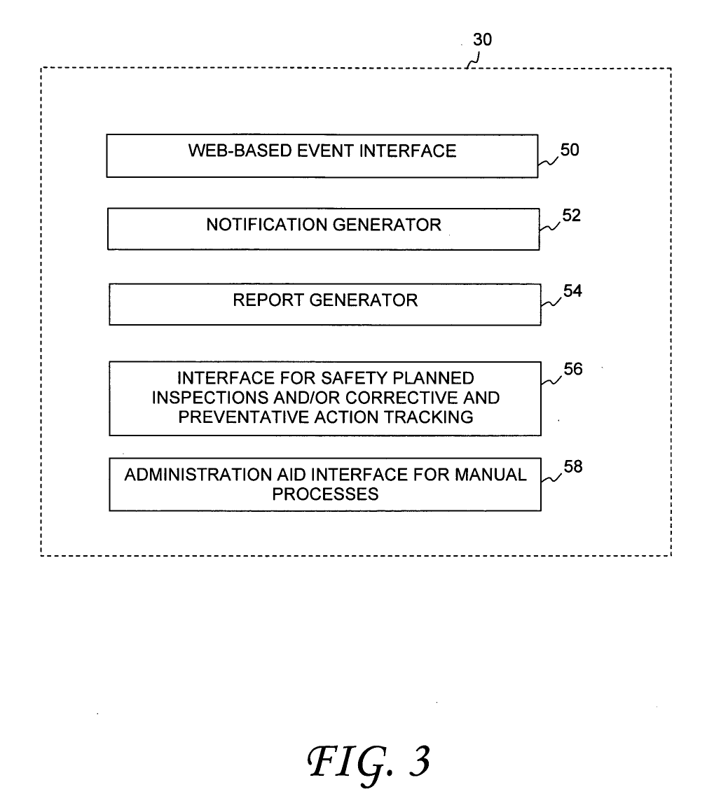

Referring now to FIG. 3, exemplary system features of the subject event correction and prevention system (ECAPS) program and corresponding computer-based platform will now be discussed in further detail. A first system feature 50 available in exemplary embodiments of the ECAPS application corresponds to a web-based event interface. Web interface 50 is utilized in many steps depicted in the exemplary process of FIG. 1. For example, a basic user can access web interface 50 to enter basic information about an event. An investigator can utilize web interface 50 to enter additional event details, risk assessment and cause analysis items. Corrective actions and review details can also be entered via the graphical interface provided by system feature 50. Some data entries in the web interface 50 may include a combination of drop down lists, fill in the blanks and other entries for various data fields.

Another feature of ECAPS application 30 is notification generator 52. Notification generator 52 corresponds to software in or linked to the ECAPS system that triggers a signal generator for sending notifications to users including but not limited to basic users, investigators, corrective action assignees and investigation reviewers. More particularly, notification generator 52 provides a notification to event investigators when they are assigned by a basic user or other entity. Notification generator sends a notification to corrective action assignees when they are assigned by an investigator or other entity. Notification generator 52 may be utilized to send reminder notifications to both investigators and corrective action assignees until required analysis and actions are completed and entered into ECAPS application 30. An investigator may receive a notification via generator feature 52 when all corrective actions have been completed. Notification generator 52 may send a notification to a reviewer when one is assigned to evaluate the results of the investigation and corresponding corrective actions. Finally, selected entities, including the basic user who originally entered the event into the ECAPS system, can be notified via system feature 52 when an event is closed out by a reviewer.

Continuing with the discussion of exemplary features of event correction and prevention system 30 as depicted in FIG. 3, a report generating system 54 may also be included in the event correction and prevention system 30. Report system 54 is adapted to generate reports in a variety of different predetermined or customized formats. Exemplary reports, include but are not limited to a report for a single event, a report summarizing a number of events, a corrective action summary report, a report showing which investigations or corrective actions are overdue, a report summarizing injuries and illnesses by nature(s) and/or body part(s), a safety loss pyramid report, etc. In some embodiments, reporting functionality via report generator 54 can be expanded to meet regulatory requirements for corrective and preventative action (CAPA) logs and trend analysis that may be required by management review in certain corporate environments. Reports can be generated automatically or the information can be exported to a supplemental program such as Microsoft( Excel to allow data to be used in customized formats or modified to suit specific purposes for a report. Reports generated via system feature 54 can serve as a key source of information in determining potential opportunities for correcting events and planning for the prevention of future events.

A still further system feature associated with some embodiments of the subject event correction and prevention system includes an interface 56 for safety planned inspections and/or corrective and preventative action tracking. Safety planned inspections can include follow-up and tracking of quality-related events and recording of any findings and follow-ups associated with quality audits. If a finding or group of findings resulting from an inspection or audit is deemed to require a full investigation, an event can be entered into the subject event correction and prevention system and tied back to the inspection. Furthermore, system feature 56 can be utilized to track any type of corrective and preventative action (CAPA) required by internal procedures or regulatory requirements.

A still further feature of event correction and prevention system 30 corresponds to a software interface 58 that can be used as an aid in administering manual processes. For example, one such process, referred to as safety management and assessment rating tool (SMART) is used to assist multiple operating facilities and staff organizations in evaluating their safety and hygiene systems to identify potential areas for improvement and also provide established accident reporting. Another manual process developed and implemented at the facility level with which system feature 58 may provide integral coupling is a manual investigation process for unplanned events such as injuries and illnesses, near misses, property damage, process loss, etc.

The subject event correction and prevention system and related methodology contains functionality to handle multiple languages and can be used for global tracking and reporting of safety trends. Information about events associated with particular assets can be utilized as input for design safety reviews.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention, which is more particularly set forth in the appended claims. Furthermore, those of ordinary skill in the art will appreciate that the foregoing description is by way of example only, and is not intended to limit the invention.

What is claimed is:

1. A method of recording and analyzing unplanned events in a Computer networked corporate environment, said method comprising the following steps:
entering into a computer-based system basic information about an unplanned event, wherein the basic information comprises at least a date, time and location of occurrence as well as an event classification;
investigating the unplanned event to determine additional event details including at least one risk assessment rating and one or more cause analysis items and entering the additional determined details into the computer-based system;
assigning and completing a corrective action for selected cause analysis items identified in said investigating step, wherein each corrective action and a corresponding completion date is entered into the computer-based system; and
storing selected pieces of information entered into the computer-based system in at least one dedicated database.

2. The method of claim 1, further comprising a step of automatically sending a notification to an investigator upon completion of said step of entering basic information into the computer-based system.

3. The method of claim 1, further comprising a step of sending an electronic notification to one or more selected individuals for each of the corrective actions and corresponding cause analysis items determined in said identifying step.

4. The method of claim 1, further comprising the steps of:
assigning a reviewer to the unplanned event; and
the reviewer evaluating the results of said investigating step and determining the effectiveness of said step of completing a corrective action for each cause analysis item.

5. The method of claim 4, further comprising a step of a reviewer closing out the unplanned event in the computer-based system.

6. The method of claim 1, wherein the event classification entered in said step of entering basic information comprises one or more of an injury, an illness, property damage, process loss, environmental loss, and a near miss.

7. The method of claim 1, further comprising a step of assigning multiple sub-events to the unplanned occurrence having basic information provided in said entering step, wherein each sub-event is characterized by a respective event classification, and wherein said investigating and assigning steps are completed for each assigned sub-event.

8. The method of claim 1, wherein each cause analysis item determined in said investigating step is characterized by a category selected from the group of immediate causes, basic causes and system needs.

9. The method of claim 1, further comprising a step of generating a report including selected information stored in the at least one dedicated database.

10. The method of claim 1, wherein the at least one risk assessment rating determined in said investigating step comprises one or more of a frequency rating of the event type within the corporate environment, a probability of occurrence of the event type and a severity rating associated with the event type.

11. The method of claim 1, wherein the event classification provided in said event step comprises an event classification selected from a display of a plurality of predefined classification types.

12. The method of claim 1, further comprising a step of a user logging into the computer-based system via a secure network link to view an event interface and enter selected information via the event interface.

13. An event correction and prevention system for managing and analyzing unplanned occurrences in a business environment, the system comprising:
a network adapted to permit data transfer among one or more basic users, one or more event investigators and one or more corrective action assignees;
at least one first data entry system adapted to permit basic users to access said network and enter basic information about an unplanned occurrence, wherein the basic information comprises the date and location of the unplanned occurrence and one or more event classifications associated with the unplanned occurrence;
at least one second data entry system adapted to permit assigned investigators to access said network and enter detailed information about each of the one or more event classifications associated with the unplanned occurrence;
at least one third data entry system adapted to permit corrective action assignees to access said network and provide corrective action details and completion dates for one or more causes identified for each of the one or more event classifications; and
an application database coupled to said network and configured to store selected information entered via the at least one respective first, second and third data entry systems.

14. The event correction and prevention system of claim 13, wherein one or more of said at least one respective first, second and third data entry systems are adapted to generate reports from selected information stored in said application database.

15. The event correction and prevention system of claim 13, wherein said at least one respective first, second and third data entry systems are linked to a web page that provides a graphical interface for users to respectively enter selected information.

16. The event correction and prevention system of claim 13, wherein said at least one first data entry system comprises means for selecting an event classification for each of the one or more event classifications associated with the unplanned occurrence from a displayed list of a plurality of predetermined event classifications.

17. The event correction and prevention system of claim 13, wherein said network comprises one of the Internet and an intranet.

18. The event correction and prevention system of claim 13, further comprising a signal generator for sending notifications to selected of the basic users, assigned investigators and corrective action assignees.

19. A computer-based application for managing and analyzing unplanned events occurring within a given corporate environment, said application comprising:
a data entry interface for basic users, assigned event investigators and corrective action assignees to enter information about each unplanned event, wherein said data entry interface provides data fields corresponding to information including a date, time and location for the unplanned event and one or more event classifications associated with the unplanned event, whereby event information entered via said data entry interface is stored in an application database;
a signal generator configured to send a plurality of notifications, said plurality of notifications including a notification to at least one investigator upon being assigned to an unplanned event by a basic user and a notification to at least one corrective action assignee upon being assigned to a corrective action by an investigator; and
a report generator configured to collect selected information from the application database and present it to a user in one of a predetermined or a customized format.

20. The computer-based application of claim 19, further comprising an interface for entering information from safety planned inspections that follow up and track quality related aspects of an event investigation.

21. The computer-based application of claim 19, further comprising an interface for tracking any type of corrective and preventative actions required by internal procedure of the given corporate environment or by regulatory requirement.

22. The computer-based application of claim 19, further comprising an interface for aiding in the implementation of a manual process associated with a given event investigation.

23. The computer-based application of claim 22, wherein the manual process comprises a safety management and assessment rating tool for evaluating safety and hygiene aspects of the given corporate environment.

24. The computer-based application of claim 19, wherein said signal generator sends selected of the plurality of notifications via electronic mail.

25. The computer-based application of claim 19, wherein said signal generator is further configured to send reminder notifications to the at least one event investigator and the at least one corrective action assignee at predetermined intervals until investigation details and corrective action information are respectively entered via said data entry interface.

26. The computer-based application of claim 19, wherein said signal generator is further configured to send a notification to a reviewer upon being assigned a task of evaluating performance aspects of the at least one investigator and the at least one corrective action assignee.

27. The computer-based application of claim 19, wherein selected of the data fields provided in said data entry interface comprise drop down lists for selecting from respective pluralities of predefined options for populating each data field.

28. The computer-based application of claim 19, wherein said report generator is configured to export upon user request selected information collected from the application database to a supplemental computer-based program.

29. An article of manufacture comprising a program storage medium readable by a computer having a memory, the medium tangibly embodying one or more programs of instructions executable by the computer to perform method steps for recording and analyzing unplanned events in a networked corporate environment, said method comprising the following steps:
interfacing with the one or more programs of instruction via a data entry interface to provide descriptive information about an unplanned event, wherein the descriptive information comprises at least one of the date, time and location of occurrence of the unplanned event as well as an event classification;
sending automatic notification of the unplanned event to an assigned event investigator who is chosen to determine additional details concerning the unplanned event and assign to selected individuals the implementation of one or more corrective actions;
sending automatic notification to one or more corrective action assignees informing the assignees of their assigned corrective actions; and
interfacing with the one or more programs of instruction to enter details of the one or more corrective actions and a completion date when each corrective action is completed by the one or more respective corrective action assignees.

30. The article of manufacture of claim 29, wherein said method further comprises a step of sending automatic notification to an assigned reviewer upon completion of said interfacing steps, wherein the reviewer is chosen to evaluate the actions undertaken by the event investigator and the one or more corrective action assignees.

31. The article of manufacture of claim 29, wherein said method further comprises a step of storing selected information provided in said interfacing steps into at least one database accessible by the computer executing said one or more programs of instruction.

32. The article of manufacture of claim 31, wherein said method further comprises a step of generating a report including selected information stored in the at least one database.

33. The article of manufacture of claim 29, further comprising a step of interfacing with the one or more programs of instruction to close out the unplanned event.

34. The article of manufacture of claim 29, wherein the event classification entered in said first interfacing step comprises one or more of an injury, an illness, property damage, process loss, environmental loss, and a near miss.

35. The article of manufacture of claim 29, where said method further comprises a step of requesting user login to access the one or more programs of instruction.
